(19) United States
(12) Patent Application Publication
(10) Pub. No.: US 2011/0318610 A1
(43) Pub. Date: Dec. 29, 2011

(54) PRODUCTION OF HYDROGEN PEROXIDE

(75) Inventors: Korneel P.H.L.A. Rabaey, Wachtebeke (BE); Rene A. Rozendal, Amsterdam (NL)

(73) Assignee: THE UNIVERSITY OF QUEENSLAND, St. Lucia (AU)

(21) Appl. No.: 13/124,534

(22) PCT Filed: Oct. 15, 2009
(86) PCT No.: PCT/AU2009/001355

§ 371 Date: Sep. 12, 2011

(30) Foreign Application Priority Data
Oct. 15, 2008 (AU) 2008905337

(51) Int. Cl. C25B 1/30; C25B 9/00; C25B 11/06; H01M 8/16

(52) U.S. Cl. 429/2; 205/466; 204/263

(57) ABSTRACT

A process for producing hydrogen peroxide comprising the steps of providing a bioelectrochemical system having an anode and a cathode, feeding a feed solution containing organic or inorganic (or both) material to the anode, oxidising the organic or inorganic material at the anode, providing an aqueous stream to the cathode of the bioelectrochemical system, reducing oxygen to hydrogen peroxide at the cathode, and recovering a hydrogen peroxide containing stream from the cathode.

### FIELD OF THE INVENTION

The present invention relates to a process for producing hydrogen peroxide. More particularly, the present invention relates to a process for producing hydrogen peroxide from aqueous waste streams using bioelectrochemical systems.

### BACKGROUND

Hydrogen peroxide is a potent oxidant with many industrial applications. Besides being used as a disinfectant, it is used for pulp and paper bleaching, detergents, wastewater treatment, chemical syntheses, metallurgy, in the textile industry and in the electronics industry (Fierro et al., Angew. Chem. Int. Ed. 2006, 45, 6962-6984). On large scale hydrogen peroxide is predominantly produced using the anthraquinone autooxidation process (AO process) or Riedl-Pfleiderer process. In this process the anthraquinone is reduced with hydrogen gas and subsequently oxidised again with oxygen. During the oxidation step hydrogen peroxide is formed. The resulting net reaction is:

H₂+O₂→H₂O₂ (equation 1)

The AO process is by far the most applied technology for the production of hydrogen peroxide and accounts for over 95% of the worldwide hydrogen peroxide production (Fierro et al., Angew. Chem. Int. Ed. 2006, 45, 6962-6984). However, alternative approaches also exist. One of the alternative approaches is the hydrogen peroxide production through conventional electrochemical processes. Of these conventional electrochemical processes two main approaches exist: (i) the electrolyser type approach (e.g., Foller and Bombard, J. Appl. Electrochem. 1995, 25, 613-627), and (ii) the fuel cell type approach (e.g., Yamanaka, Angew. Chem. Int. Ed. 2003, 42, 3653-3655). The electrolyser approach is based on a chemically catalyzed anode that generates oxygen:

Anode (acid conditions): H₂O→0.5O₂+2H⁺+2e⁻ (equation 2a)

Anode (alkaline conditions): 2OH⁻→0.5O₂+H₂O+2e⁻ (equation 2b)

The fuel cell approach is based on a chemically catalyzed anode that consumes hydrogen:

Anode (acid conditions): H₂→2H⁺+2e⁻ (equation 3a)

Anode (alkaline conditions): H₂+2OH⁻→2H₂O+2e⁻ (equation 3b)

In both approaches the anode is coupled to a chemically catalyzed cathode that reduces oxygen to form hydrogen peroxide.

Cathode (acid conditions): O₂+2H⁺+2e⁻→H₂O₂ (equation 4a)

Cathode (alkaline conditions): O₂+H₂O+2e−→HO₂⁻+OH⁻ (equation 4b)

Unfortunately, both approaches require significant energy inputs. The electrolyser approach requires significant energy inputs due to the large electricity consumption; the fuel cell approach requires significant energy inputs due to the large hydrogen consumption. This renders these processes expensive and often not economically viable.

Bioelectrochemical systems, such as microbial fuel cells and microbial electrolysis cells, are generally regarded as a promising future technology for the production of energy from organic material present in waste waters. Industrial, agricultural and domestic waste waters typically contain dissolved organics that require removal before discharge into the environment. Typically, these organic pollutants are removed by aerobic treatment, which can assume to large amounts of electrical energy for aeration.

Recently, bioelectrochemical systems have emerged as potentially interesting technology for the production of energy and products from aqueous waste streams (e.g., wastewater). Bioelectrochemical systems are based on the use of electrochemically active microorganisms, which transfer the electrons to an electrode (anode) while they are oxidising (and thus removing) (in)organic pollutants in aqueous waste streams (e.g., wastewater). Bioelectrochemical wastewater treatment can be accomplished by electrically coupling such a biocatalysed anode to a counter electrode (cathode) that performs a reduction reaction. As a result of this electrical connection between the anode and the cathode, the electrode reactions can occur and electrons can flow from the anode to the cathode. The bioelectrochemical system may operate as a fuel cell (in which case electrical energy is produced) or as an electrolysis cell (in which case, electrical energy is fed to the bioelectrochemical system). Examples of bio-electrochemical systems are microbial fuel cells for electricity production (Rabaey and Verstraete, Trends Biotechnol. 2005, 23, 291-298) and biocatalyzed electrolysis for the production of hydrogen gas (Patent WO2005005981A2).

It has been suggested in literature that hydrogen peroxide might sometimes be formed as a byproduct in microbial fuel cells (Bond and Lovley, Appl. Environ. Microbiol. 2003, 69, 1548-1555), although such hydrogen peroxide is normally destroyed very quickly. Clauwaert et al., Appl. Microbiol. Biotechnol., 2008, 79, 901-913, have also discussed, in the context of reverse osmosis filtration, that it should be possible to exploit this cathodic formation of hydrogen peroxide for combined disinfection and pollutant removal in combination with anodic COD removal. This process would combine disinfection with pollutant removal and thus prevent heterotrophic pathogens becoming dominant in the reverse osmosis filtrates. However, up until now, bioelectrochemical systems have not been deployed for the development of a large-scale industrial hydrogen peroxide production process. Such a process should be capable to produce hydrogen peroxide on a large scale and produce hydrogen peroxide that complies with the product demands from industries such as the pulp and paper industry. Such a bio-electrochemical process does not currently exist.

### DESCRIPTION OF THE INVENTION

It is an object of the present invention to provide an apparatus and a process for producing hydrogen peroxide as an end product using a bioelectrochemical system.

In the first aspect, the present invention provides a process for producing hydrogen peroxide comprising the steps of providing a bioelectrochemical system having an anode and a cathode, feeding a feed solution containing organic or inorganic (or both) material to the anode, oxidising the organic or inorganic material at the anode, providing an aqueous stream to the cathode of the bioelectrochemical system, reducing oxygen to hydrogen peroxide at the cathode, and recovering a hydrogen peroxide containing stream from the cathode.

In a second aspect, the present invention provides a bioelectrochemical system for producing hydrogen peroxide comprising an anode chamber having an anode, an anode liquid inlet for feeding an aqueous waste stream to the anode chamber, an anode liquid outlet for removing a liquid from the anode chamber, the anode comprising a biocatalyzed anode which oxidises organic or inorganic materials in the aqueous waste stream fed to the anode chamber, a cathode chamber having a cathode, a cathode liquid inlet for feeding an aqueous stream to the cathode chamber, a cathode liquid outlet for removing a product stream containing hydrogen peroxide from the cathode chamber, an ion permeable membrane between the anode chamber and the cathode chamber to allow the transfer of ions between the anode chamber and the cathode chamber and an electrical circuit connecting the anode to the cathode.

As will be understood by persons skilled in the art, the bioelectrochemical system used in the present invention will include electrochemically active microorganisms associated with at least the anode or anode compartment, which transfer electrons to an electrode (anode) while they are oxidising (in)organic pollutants in aqueous waste streams (e.g., wastewater).

In one embodiment, the system further comprises a cathode gas inlet for feeding an oxygen containing gas to the cathode chamber. The system may also further comprise a cathode gas outlet for removing surplus gas from the cathode chamber.

The invention provides a bioelectrochemical system suitable for the production of hydrogen peroxide from aqueous waste streams (e.g. wastewater) by utilising a bioelectrochemical cell or bioelectrochemical system. This bioelectrochemical cell or bioelectrochemical system contains an anode that oxidizes organic (e.g. volatile fatty acids) and/or inorganic materials (e.g., sulfide) in aqueous waste streams (e.g., wastewater) and a cathode that reduces oxygen to hydrogen peroxide. The anode reaction is catalyzed by microorganisms, such as electrochemically active microorganisms, and generates electrons (e) and protons and/or carbon dioxide and/or other oxidation products (e.g. sulfur).

Anode: (In)organic materials→xHCO₃⁻+yH⁺+ze⁻+other products (equation 5)

The electrons (e) that are generated in the oxidation reaction are transferred to the anode and transported from the anode to the cathode via an electrical circuit. The cathode may be catalyzed chemically and consumes electrons for the reduction of oxygen to hydrogen peroxide. The cathode reactions are as follows:

Cathode (acid conditions): O₂+2H⁺+2e⁻H₂O₂ (equation 6a)

Cathode (alkaline conditions): O₂+H₂O+2e−→HO₂⁻+OH⁻ (equation 6b)

An anode that oxidizes (in)organic materials in aqueous waste streams (e.g. wastewater) typically exhibits an electrode potential of about −0.3 to −0.2 V (at pH 7) (all electrode potentials given throughout this specification are measured relative to a standard hydrogen electrode). Depending on the pH the cathodic production of hydrogen peroxide production exhibits an electrode potential of about −0.065 (pH 14) to 0.67 V (pH 0). Hence, the overall cell potential (cathode potential minus anode potential) for the production of hydrogen peroxide using a bioelectrochemical system will typically have a positive value. This means that the bioelectrochemical production of hydrogen peroxide from aqueous waste streams is a spontaneous process and does not require any electricity input. Indeed, electrical energy could even be produced from the reaction. However, under these conditions the hydrogen peroxide production rate will be relatively low and only low concentrations (ppm level) of hydrogen peroxide are likely to be obtained, as much of the produced hydrogen peroxide is simultaneously lost as a result of self-degradation, especially at high pH values (Brillas et al., J. Appl. Electrochem., 1997, 27, 83-92), in accordance with the following equation:

2HO₂⁻→O₂+2OH⁻ (equation 7)

Low concentrations of hydrogen peroxide are suitable for in situ disinfection, but not for recovery as a product stream for other uses, such as pulp and paper bleaching. Therefore, to increase hydrogen peroxide concentration and produce a recoverable product suitable for other uses, it is desirable that hydrogen peroxide be produced at higher production rates. To achieve this, the anode and cathode may be connected to each other in short circuit, i.e., without the extraction of electrical energy. Alternatively, or further, to speed up the process even further, an external power source can optionally be connected between the anode and the cathode. Using this power supply, an external voltage may be applied to the system, which speeds up the electrode reactions and increases the hydrogen peroxide production rates.

In one embodiment of the present invention the bioelectrochemical system comprises an anode chamber and a cathode chamber separated by an ion permeable membrane, as known to the person skilled in the art. Ion permeable membranes suitable for use in the present invention include any ion permeable membranes that may be used in bioelectrochemical systems (Kim et al., Environ. Sci. Technol., 2007, 41, 1004-1009; Rozendal et al., Water Sci. Technol., 2008, 57, 1757-1762). Such ion permeable membranes may include ion exchange membranes, such as cation exchange membranes and anion exchange membranes. Porous membranes, such as microfiltration membranes, ultrafiltration membranes, and nanofiltration membranes, may also be used in the bioelectrochemical system used in the present invention. The ion permeable membrane facilitates the transport of positively and/or negatively charged ions through the membrane, which compensates for the flow of the negatively charged electrons from anode to cathode and thus maintains electroneutrality in the system.

In other embodiments, rather than having an anode chamber and the cathode chamber, the bioelectrochemical cell may comprise an open flow system.

The bioelectrochemical system comprises an anode and a cathode. The anode may comprise an electrically conductive material that can interact with the electrochemically active microorganisms. Preferable the anode consist of an electrically conductive material that allows for the attachment of electrochemically active micro-organisms. Examples of such anode materials are carbon and/or graphite. Metals or metal alloys may also be used as the anode material.

The cathode may comprise an electrically conductive material that is catalytic toward the formation of hydrogen peroxide from oxygen (e.g., from air—Equation 6). Suitable materials for electrochemical hydrogen peroxide production are known to the person skilled in the art and include carbon materials, gold, and quinone-modified glassy carbon electrodes (Foller and Bombard, J. Appl. Electrochem., 1995, 25, 613-627; Vail et al., J. Electroanal. Chem., 2004, 564, 159-166). Optionally these materials can be supported on a suitable current collector. The current collector may comprise a metal. A suitable material for this purpose is nickel, as it is not catalytic towards the decomposition of hydrogen peroxide (Foller and Bombard, J. Appl. Electrochem., 1995, 25, 613-627). An unsuitable material for this purpose is iron or steel, as it is catalytic towards the decomposition of hydrogen peroxide (Foller and Bombard, J. Appl. Electrochem., 1995, 25, 613-627). Generally, it is desirable to avoid using a material that is catalytic towards the decomposition of hydrogen peroxide in the cathode chamber.

The anode and the cathode are connected to each other by an electrical circuit. In one embodiment, the electrical circuit may comprise a conductor having very low resistance such that the conductor acts as an electrical short circuit between the anode and the cathode. In another embodiment, a power supply may be included in the electrical circuit. This power supply can be used to apply a voltage on the system, which increases the hydrogen peroxide production rate. The voltage applied with a power supply between the anode and the cathode may be between 0 and 2.5 V, preferably between 0 and 1.5 V, more preferably between 0 and 1.0 V. This may result in a volumetric current density in the bioelectrochemical cell of between 0 and 10,000 A/m³ of bioelectrochemical cell, preferably between 10 and 5,000 A/m³ of bioelectrochemical cell, more preferably between 100 and 2500 A/m³ of bioelectrochemical cell and/or an area specific current density of between 0 and 1,000 A/m² membrane surface area, preferably between 1 and 100 A/m² membrane surface area, more preferably between 2 and 25 A/m² membrane surface area.

In embodiments that include an anode chamber, the anode chamber may be typically provided with an aqueous waste stream (e.g., wastewater) through an anode chamber liquid inlet. Inorganic or organic material (or both) in this stream is oxidized by electrochemically active bacteria in the anode chamber that interact with the electrode and an effluent stream leaves the anode chamber through an anode chamber liquid outlet.

In embodiments that include a cathode chamber, the cathode chamber may be provided with water or an aqueous stream through a cathode chamber liquid inlet. Optionally hydrogen peroxide stabilizers such as EDTA, colloidal silicate, colloidal stannate, sodium pyrophosphate, organophosphonates, nitric acid, and/or phosphoric acid may be added to this water or aqueous stream. Other hydrogen peroxide stabilisers known to the person skilled in the art may also be used. The water flow to the cathode chamber may be varied to obtain the desired product concentration of hydrogen peroxide. Typical product concentrations of the hydrogen peroxide in the product stream may fall between 0.01 and 30 wt % preferably between 0.1 and 10 wt %, more preferably between 1 and 8 wt %.

In another embodiment, the bioelectrochemical system may hang in or be suspended in a bioreactor, and it may include a tubular membrane, with the anode on the outside of the tubular membrane and the peroxide generating cathode on the inside of the tubular membrane. In this case the anode has no inlet. In a similar employment, the cathode may be on the outside of the tubular membrane and the anode on the inside of the tubular membrane. In this case, the cathode has no inlet.

There may also be other embodiments where the membrane may comprise a fluid permeable membrane such a fluid can flow across the membrane. In such embodiments, it may not be necessary to have an inlet to one of the cathode or the anode.

The cathode may also be provided with oxygen (e.g., from air) through a cathode chamber gas inlet. Hydrogen peroxide is produced at the cathode and an aqueous product stream containing the hydrogen peroxide leaves the cathode chamber through a cathode chamber liquid outlet. The cathode chamber may be provided with a gas outlet such that a surplus of gas provided through the gas inlet leaves the system through the gas outlet.

In other embodiments, the aqueous stream provided as a feed to the cathode chamber may comprise an oxygenated or an aerated aqueous stream.

Since the cathode reaction (equation 6) either consumes protons or produces hydroxyl ions, the pH will typically increase in the cathode chamber. In fact, this principle can exploited in a specific embodiment of the invention. In this specific embodiment the ion permeable membrane that separates the anode and the cathode chamber comprises a cation exchange membrane. Cation exchange membranes are known to the person skilled in the art and include membranes such as CMI-7000 (Membranes International), Neosepta CMX (ASTOM Corporation), Fumasep® FKB (Fumatech), and Nafion (DuPont). In cases where a cation exchange membrane is used as the membrane in the bioelectrochemical system, cations are transported from the anode to the cathode to compensate for the negative charge of the electrons flowing from anode to cathode through the electrical circuit. Since aqueous waste streams, especially wastewaters, are typically about pH neutral, the cations that are transported through the cation exchange membrane are typically not protons, but comprise other cations present in the aqueous waste streams, such as sodium and potassium. At the cathode these cations combine with the hydroxyl ions that are produced in the cathode reaction (equation 6). As hydrogen peroxide is still produced, this embodiment of the invention produces a mixture of a hydroxide material (such as sodium hydroxide or potassium hydroxide) and hydrogen peroxide. Mixtures of sodium hydroxide and hydrogen peroxide are used widely industry, for example for bleaching purposes in the pulp and paper industry. The ratio of sodium hydroxide to hydrogen peroxide in the product stream of this embodiment of the inventions may be between 0.1:1 and 10:1, preferably between 0.5:1 and 5:1, more preferably between 1:1 and 3:1. If desired, the ratio of the product stream can be changed according to needs by adding merchant caustic soda or hydrogen peroxide.

If the level of multivalent ions (e.g, calcium) is high in the aqueous waste streams (e.g., wastewater) that is fed to the anode chamber, there exists a risk of scaling of the cation exchange membrane due to precipitation of calcium salts (e.g., calcium hydroxide) on the cathode side of the membrane. This can irreversibly damage the membrane. This risk is especially high if the ion permeable membrane allows multivalent ions to pass therethrough. To prevent scaling damage to the membrane the cation exchange membrane may be a special type of cation exchange membrane, namely a monovalent ion selective cation exchange membrane (Balster et al., J. Membr. Sci., 2005, 263, 137-145). Monovalent ion selective cation exchange membranes are known to the person skilled in the art and include Neosepta CIMS (ASTOM Corporation). Monovalent ion selective cation exchange membranes selectively transport monovalent cations (e.g., sodium, potassium) and prevent multivalent cations (e.g, calcium) being transported therethrough. Therefore, the amount of multivalent ions reaching the cathode side of the membrane is significantly reduced and the scaling risk diminishes. An additional advantage gained by using monovalent ion selective cation exchange membranes is that traces of iron ions, which might be present in the aqueous waste stream, are blocked by the membrane too. Iron ions are well-known catalysts for the decomposition of hydrogen peroxide.

In another embodiment issues arising from scaling at the cathode can be reduced through the addition of anti-scaling agents to the cathode fluid.

In another embodiment of the invention the ion permeable membrane that separates the anode and the cathode chamber comprises an anion exchange membrane. Anion exchange membranes are known to the person skilled in the art and include membranes such as AMI-7001 (Membranes International), Neosepta AMX (ASTOM Corporation), and fumasep FAA® (fumatech). In cases where an anion exchange membrane is used as the membrane in the bioelectrochemical system, anions are transported from the cathode to the anode to compensate for the negative charge of the electrons flowing from anode to cathode through the electrical circuit. As cations are blocked completely by the anion exchange membrane, multivalent cations cannot be transported from anode to cathode and scaling issues are prevented. Moreover, also iron ions are blocked so if iron is present in the aqueous waste stream decomposition of the hydrogen peroxide is prevented.

In this specific embodiment the cathode chamber is also provided with water or an aqueous stream through a cathode chamber liquid inlet. This water or aqueous stream might contain added salt ions (e.g., sodium and chloride ions) or buffer (e.g., sodium bicarbonate) to get to acceptable levels of conductivity. When current flows through the systems and hydrogen peroxide is produced, anions will be transported from cathode to anode. Unless the water or an aqueous stream contains sufficient amounts of buffer, the pH will also increase in the cathode chamber of this specific embodiment. Under alkaline conditions (equation 6b) hydrogen peroxide might be present as the hydroperoxide ion (i.e., HO₂⁻). Since the hydroperoxide ion is a negatively charged ion as well, it can be transported through an anion exchange membrane as well. In that case the hydrogen peroxide is lost from the product stream. To prevent this from happening, the pH can be controlled in the cathode by adding an acid (e.g., hydrochloric acid and/or carbon dioxide) to a level that the hydroperoxide ion is not formed. This prevents the hydroperoxide ion from being transported through the anion exchange membrane and being lost from the product stream.

In another embodiment of the invention the ion permeable membrane that separates the anode and the cathode chamber comprises a bipolar membrane. Bipolar membranes are known to the person skilled in the art and include membranes such as NEOSEPTA BP-1E (ASTOM Corporation) and Fumasep® FBM (Fumasep). Bipolar membranes are composed of a cation exchange layer on top of an anion exchange layer and rely on the principle of water splitting into protons and hydroxyl ions in between the ion exchange layers of the membrane, according to:

H₂O→H⁺+OH⁻ (Equation 8)

In cases where a bipolar membrane is used as the membrane in the bioelectrochemical system, the anion exchange layer is directed towards the anode chamber and the cation exchange layer is directed towards the cathode chamber. When electrical current flows, water diffuses in between the ion exchange layers and is split into protons and hydroxyl ions. The hydroxyl ions migrate through the anion exchange layer into the anode chamber, where they compensate for the proton production in the anode reaction (equation 5) and the protons migrate through the cation exchange layer into the cathode chamber where they compensate for the hydroxyl ion production (or proton consumption) in the cathode reaction (equation 6). As a result of this, pH may be kept constant in the cathode chamber without adding acid. Furthermore, because other anions and cations are not transported through the bipolar membrane, multivalent cations cannot be transported from anode to cathode either and scaling issues are prevented. Moreover, also iron ions are blocked so if iron is present in the aqueous waste stream decomposition of the hydrogen peroxide is prevented.

In this specific embodiment the cathode chamber is provided with water or an aqueous stream through a cathode chamber liquid inlet. This water or aqueous stream might contain added salt ions (e.g., sodium and chloride ions) or buffer (e.g., sodium bicarbonate) to get to acceptable levels of conductivity.

In another embodiment of the invention ion permeable membrane is porous membrane. Porous membranes are known to the person skilled in the art and include microfiltration membranes, ultrafiltration membranes, and nanofiltration membranes. In this specific embodiment a fraction or the complete flow of the aqueous waste stream is directed through the porous membrane from anode to cathode. In this case the water or aqueous stream entering the cathode chamber through cathode chamber liquid inlet in the other described embodiments may be reduced or eliminated.

In another embodiment of the invention the water or an aqueous stream enters the cathode through the cathode chamber liquid in between the cathode and the membrane in such a way that the fluid flow through the cathode chamber is perpendicular to the membrane in the direction of the cathode. This can be achieved by sending fluid through a porous membrane or by introducing a space and/or spacer in between the membrane and the cathode and by directing the liquid through this space and/or spacer. Such a spacer is known to a person skilled in the art.

In another embodiment of the invention a gas diffusion electrode is used as the cathode (e.g., Foller and Bombard, J. Appl. Electrochem. 1995, 25, 613-627; Yamanaka, Angew. Chem. Int. Ed. 2003, 42, 3653-3655). This gas-diffusion electrode is directly exposed to air or oxygen, which guarantees sufficient availability of oxygen and benefits hydrogen peroxide formation. The cathode chamber is in between the ion permeable membrane and the gas diffusion electrode. Gas-diffusion electrodes are known to the person skilled in the art and include electrodes made of carbon powder (e.g. vapor-grown carbon-fiber (VGCF), Showa-Denko Co.) mixed with poly(tetrafluoroethylene) powder (PTFE) (e.g., as describied in Foller and Bombard, J. Appl. Electrochem. 1995, 25, 613-627; Yamanaka, Angew. Chem. Int. Ed. 2003, 42, 3653-3655).

### BRIEF DESCRIPTION OF THE DRAWINGS

FIG. 1 shows a schematic diagram of an apparatus suitable for use in an embodiment of the process of the present invention;

FIG. 2 shows a schematic diagram of an apparatus utilizing a gas diffusion electrode as the cathode and suitable for use in an embodiment of the present invention;

FIG. 3 shows a schematic diagram of the reactions taking place in an embodiment of the present invention;

FIG. 4 is a graph of cell voltage and electrode potentials vs current for the bioelectrochemical system operated in accordance with the Example; and

FIG. 5 is a graph of cumulative charge vs time for the bioelectrochemical system operated in accordance with the Example.

### DETAILED DESCRIPTION OF THE DRAWINGS

It will be appreciated that the drawings have been provided to illustrate preferred embodiments of the present invention. Therefore, it will be understood that the present invention should not be considered to be limited solely to the features as shown in the drawings.

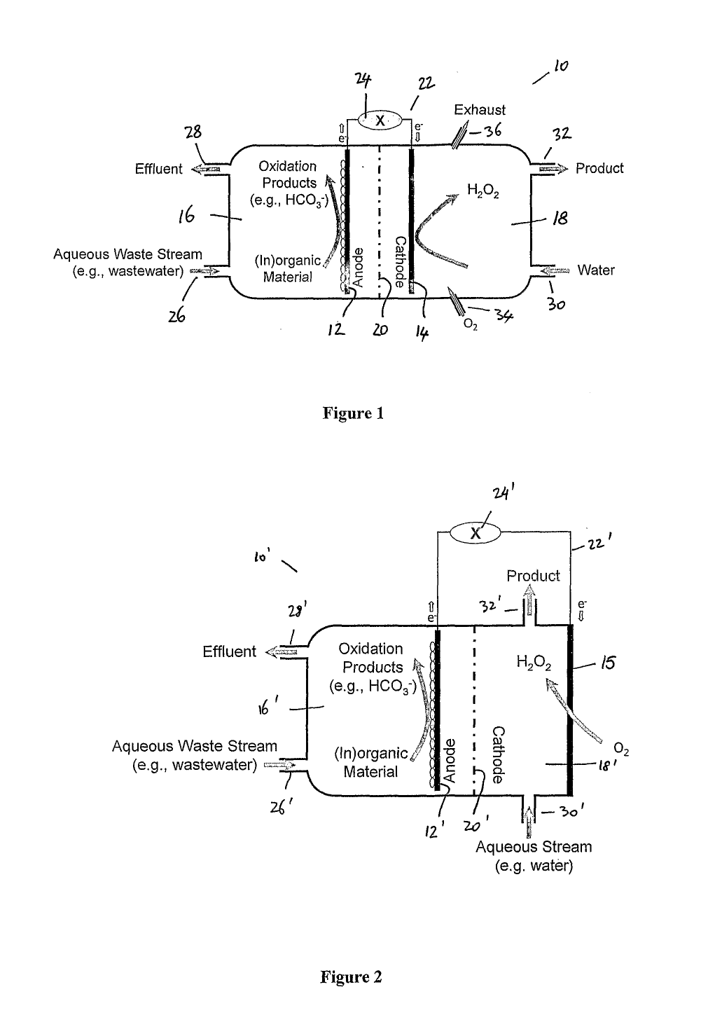

The apparatus shown in FIG. 1 includes a bioelectrochemical system 10 that has an anode 12 and a cathode 14. The system includes an anode chamber 16 and a cathode chamber 18. An ion permeable membrane 20 is positioned between the anode and the cathode. An electrical circuit 22, which may simply comprise an electrically conductive wire, connects the anode to the cathode and allows the transfer of electrons therebetween. A battery 24 or other voltage source/power supply may be provided to increase the rate of production of hydrogen peroxide.

The anode chamber includes an anode liquid inlet 26 and an anode liquid outlet 28. An aqueous waste stream, such as a wastewater stream, is supplied to the anode chamber 16 through the anode liquid inlet 26. The aqueous waste stream contains organic and/or inorganic material. This organic or inorganic material is oxidised by the electrochemically active microorganisms or bacteria in the anode chamber to produce oxidation products (such as those described in equation 5 above). Protons and electrons are also generated by the oxidation reactions that take place in the anode chamber.

It will be appreciated that the oxidation reactions that take place in the anode chamber not only generate electrons but they also act to purify or at least reduce the contaminant levels in the aqueous waste stream that is fed to the anode chamber 16 by virtue of the oxidation of the organic or inorganic components in the anode chamber. The thus-treated aqueous stream is removed from the anode chamber via anode liquid outlet 28.

An aqueous stream, such as a water stream, is supplied to the cathode chamber 18 via cathode liquid inlet 30. The water stream provided to the cathode chamber 18 may include one or more stabilisers for stabilising hydrogen peroxide. The cathode chamber 18 is also provided with a cathode liquid outlet 32. A hydrogen peroxide containing liquid product stream is removed from the cathode chamber 18 via the cathode liquid outlet 32.

As will be appreciated from equation 6a and equation 6b given above, production of hydrogen peroxide in the cathode chamber involves the reduction of oxygen. In order to provide the oxygen necessary for hydrogen peroxide production, the water stream fed to the cathode chamber 18 may comprise an oxygenated or aerated water stream. Alternatively, as shown in FIG. 1, oxygen or air may be introduced into the cathode chamber through gas inlet 34. In order to remove any surplus oxygen or air supplied to the cathode chamber 18, the cathode chamber 18 may also be provided with a gas outlet 36.

FIG. 2 shows a schematic diagram of an apparatus suitable for use in embodiments of the present invention. The apparatus shown in FIG. 2 has a number of features in common with the apparatus shown in FIG. 1 and for convenience the features of figure 2 that are common with the features of FIG. 1 will be denoted by the same reference numeral, but with the addition of a′ in FIG. 2. These features need not be described further.

Where the apparatus shown in FIG. 2 differs from the apparatus shown in FIG. 1 is that the cathode 14 of FIG. 1 is replaced with a gas diffusion electrode 15 that acts as the cathode. This gas-diffusion electrode 15 is directly exposed to air or oxygen, which guarantees sufficient availability of oxygen and benefits hydrogen peroxide formation. The cathode chamber 18′ is in between the ion permeable membrane and the gas diffusion electrode.

The present invention provides a process and apparatus for producing hydrogen peroxide as a product stream using a bioelectrochemical system. This process has the advantage over conventional electrochemical processes of having low external energy requirements (such as electricity and hydrogen) as the process of the present invention can use the energy content of an aqueous waste stream for the production of hydrogen peroxide. As an additional benefit, the aqueous waste stream leaving the bioelectrochemical system has a reduced level of organic or inorganic contaminants as a result of oxidation of at least some of the organic or inorganic material in the waste stream as it passes through the anode chamber.

The present invention provides a process for producing hydrogen peroxide based upon a bioelectrochemical system. The system may allow for the production of large scale industrial hydrogen peroxide production processes. The process of the present invention may be capable of producing hydrogen peroxide on a large scale and of producing hydrogen peroxide that complies with the product demands from industries such as the pulp and paper industry. In some embodiments, the hydrogen peroxide product stream may include quantities of sodium hydroxide (or other useful alkaline materials).

### EXAMPLE

### Electrochemical Cell

The experimental runs were performed in an electrochemical cell that consisted of two parallel Perspex frames (internal dimensions 14×12×2 cm) separated by a cation exchange membrane (Ultrex, Membranes International Inc., Glen Rock, N.J., USA). This construction of membrane and frames created an anode and a cathode chamber, both with an empty bed volume of 336 mL. The anode side of the electrochemical cell was separated from the outside by a Perspex plate, while the cathode side was separated from the outside by a carbon cloth gas diffusion electrode (E-TEK Specialty ELAT for Hydrogen Peroxide, BASF Fuel Cell, Inc., USA). The anode chamber was filled with granular graphite with diameter ranging from 2 to 6 mm (El Carb 100, Graphite Sales, Inc., USA) as the anode material, which reduced the liquid volume of the anode chamber to about 182 mL. A graphite rod was inserted into the bed of graphite granules to make external contact. The gas diffusion cathode was electrically connected through a stainless steel frame (SS316) current collector (internal dimensions 13.6×13.6×0.1 cm). The stainless steel frame left an exposed, projected cathode surface area of 185 cm² on the basis of which all current densities are reported. Both electrode chambers were equipped with an Ag/AgCl reference electrode (+197 mV vs NHE). The electrochemical cell was connected to a potentiostat (VMP3, Princeton Applied research, USA), which either controlled the anode potential (three-electrode setup) or the cell voltage (two-electrode setup). Anode and cathode potential were continuously monitored with a multichannel data acquisition unit (34970A Data Acquisition Unit, Agilent Technologies, USA). All electrode potentials are reported vs NHE.

### Start-Up and Operation

The anode chamber of the electrochemical cell was fed continuously (1 mL min⁻¹) with an autoclaved feed. To be able to assess the full potential of this novel bioelectrochemical technology, this feed was designed such that the buffer capacity (pH 7) and acetate content never limited anode performance. It contained (in deionized water): 1.0 g/L NaCH₃COO, 18 g/L Na₂HPO₄, 9 g/L KH₂PO₄, 0.1 g/L NH₄Cl, 0.5 g/L NaCl, 0.1 g/L MgSO₄.7H₂O, 0.015 g/L CaCl₂.7H₂O, and 1 mL/L trace nutrient solution (H. B. Lu, A. Oehmen, B. Virdis, J. Keller and Z. G. Yuan, Water Res. 40 (2006) 3838). The anode chamber was continuously mixed by recycling its contents at about 100 mL/min. The cathode chamber was filled with a 2.9 g/L NaCl solution (50 mM) and operated in batch mode.

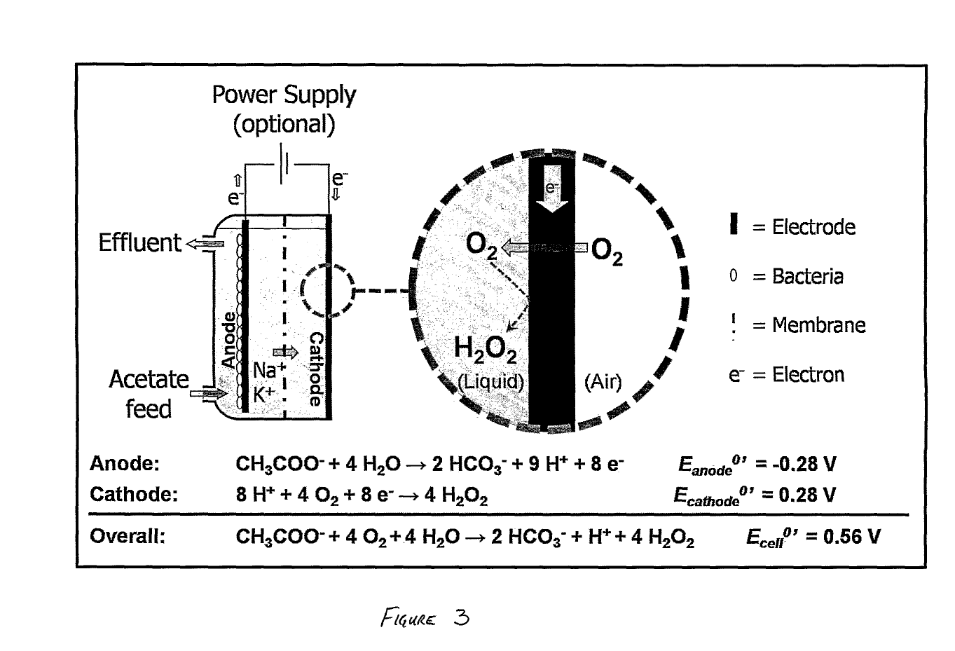

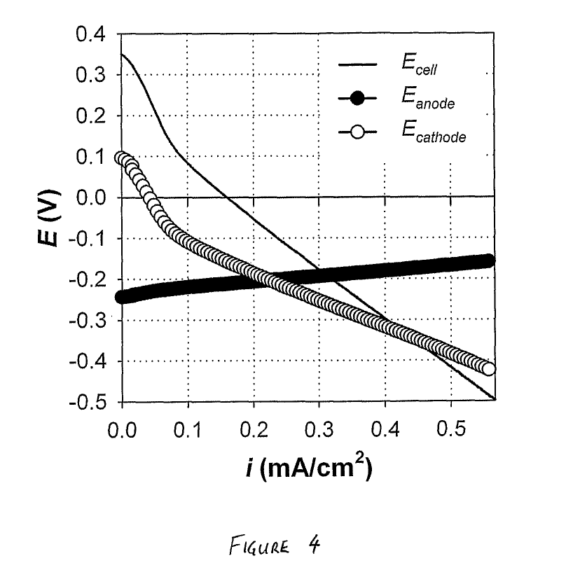

The anode chamber was inoculated with a microbial consortium taken from an MFC (microbial fuel cell) performing carbon and nitrogen removal (B. Virdis, K. Rabaey, Z. Yuan, R. A. Rozendal and J. Keller, Environ. Sci. Technol. in press (2009)). Upon inoculation, the electrochemical cell was left in open circuit for 4 days until the anode potential decreased to −0.27 V, i.e., a value close to the theoretical potential for acetate oxidation (see FIG. 3). At that moment, the electrical circuit was closed and the anode potential was controlled at −0.2 V. During the following days current production increased and stabilized at ˜0.3 mA/cm² after 2 weeks of operation. Subsequently, the BES was operated at a constant applied cell voltage of 0.5 V, i.e., an applied voltage level at which high current densities (>0.5 mA/cm²) could be maintained at a sufficiently low energy input (<1 kWh/kg H₂O₂). In absence of acetate in the feed, no current production was observed. All experiments were performed at room temperature (22±1° C.).

### Experimental Procedures and Calculations

The BES was subjected to an applied current scan. Prior to this scan, the cathode chamber of the electrochemical cell was rinsed two times and subsequently filled with a 50 mM NaCl solution. The system was first left in open circuit for 10 minutes to establish equilibrium conditions. Subsequently, starting from 0 mA, the current was increased at a scan rate of 0.1 mA/s until the applied cell voltage reached 0.5 V. Cell voltage and electrode potentials were monitored during the applied current scan.

In addition to the applied current scan, the performance of the BES was assessed during 8-hour experimental runs at an applied voltage of 0.5 V (in quintuplicate). Prior to every run, the cathode chamber of the electrochemical cell was rinsed two times and subsequently filled with a 50 mM NaCl solution. During the experimental runs, anodic influent and effluent acetate concentrations, and cathodic H₂O₂ concentration and pH were determined at 2-hour intervals. The conductivity of the catholyte was measured before and after the experimental runs. Acetate concentrations were determined using high-performance liquid chromatography (HPLC; Shimadzu); H₂O₂ concentrations were spectrophotometrically determined using the vanadate method (R. F. P. Nogueira, M. C. Oliveira and W. C. Paterlini, Talanta 66 (2005) 86); pH and conductivity were measured using a hand-held meter (Cyberscan PC 300, Eutech Instruments). Coulombic efficiency was defined as the measured charge production (integrated current over time) divided by the cumulative acetate consumption expressed as charge (based on 8 mol e⁻ produced per mol of acetate consumed; see FIG. 3); cathodic efficiency was defined as the cumulative H₂O₂ production expressed as charge (based on 2 mol e⁻ consumed per mol of H₂O₂ produced; See FIG. 3) divided by the measured charge production; and overall efficiency was defined as the cumulative H₂O₂ production expressed as charge divided by the cumulative acetate consumption expressed as charge.

### Results and Discussion

### Applied Current Scan

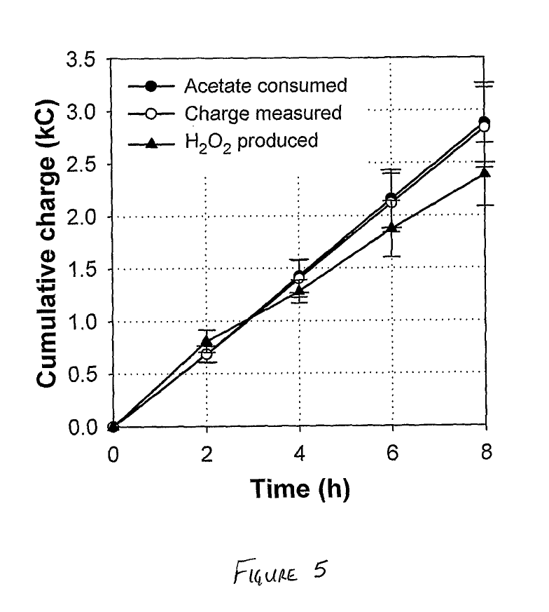

As can be seen from FIG. 4, the anode potential at open circuit (−0.24 V) was close to the standard potential for acetate oxidation (−0.28 V at pH 7; see FIG. 3), whereas the cathode potential at open circuit (0.10 V) suffered a significant potential loss of about 0.18 V in comparison to the standard potential for H₂O₂ formation (0.28 V at pH 7; FIG. 3). The resulting open circuit voltage was 0.34 V. The positive value of the open circuit voltage indicates that a net power output can theoretically be delivered by this system. During the applied current scan, the cell voltage decreased with increasing current density, but remained positive until the current density reached 0.16 mA/cm² at which point the system arrived at short circuit conditions (i.e., E_{cell}=0 V). Above this current density, the cell voltage became negative, indicating that the system required a net power input to operate.

### Performance

FIG. 4 suggests that at lower current densities bioelectrochemical H₂O₂ production can in theory be operated with simultaneous electricity production (i.e., positive cell voltage). However, under those conditions the H₂O₂ production proceeds at relatively low rates. These rates can be significantly increased by applying a voltage (i.e., negative cell voltage) and thus investing a small amount of electrical energy. Therefore, we assessed the performance of the BES at an applied voltage of 0.5 V in 8-hour experimental runs (see FIG. 5). At this applied voltage the system exhibited an average current density of 0.53±0.07 mA/cm², which is in the same range as the current density predicted by the applied current scan (see FIG. 4). The H₂O₂ concentration increased from 0 mM (or 0 wt %) at t=0 h to 38±3.9 mM (or 0.13±0.01 wt %) at t=8 h, which was equivalent to a volumetric H₂O₂ production rate of 1.9±0.2 kg H₂O₂/m³/day.

FIG. 5 depicts the efficiencies achieved during the experimental runs by plotting (i) the measured charge production, (ii) the cumulative acetate consumption expressed as charge, and (iii) the cumulative H₂O₂ production expressed as charge. The cumulative acetate consumption was equivalent to the charge production throughout the complete experimental run, which means that the coulombic efficiency (i.e., conversion of acetate to e⁻) of the BES was very high: ˜98.4±2.0% after 8 hours. The cumulative H₂O₂ production, on the other hand, deviated slightly from the charge production, particularly further into the experimental run, which lowered the cathodic efficiency (i.e., conversion of e⁻ to H₂O₂) to 84.4±5.2% after 8 hours. Still, a high overall efficiency (i.e., conversion acetate to H₂O₂) of 83.1±4.8% was achieved after 8 hours of operation.

During the experimental runs, catholyte conductivity increased from 5.5±0.1 mS/cm at t=0 h to 12.3±1.0 mS/cm at t=8 h, while the pH increased from 7.2±0.6 at t=0 h to 11.9±0.5 t=2 h and remained around pH 12 during the remainder of the experimental runs. This increase in conductivity and pH can be explained from the transport of cations other than protons through the cation exchange membrane and from the consumption of protons in the cathode reaction (see FIG. 3).

### Implications

At an applied voltage of 0.5 V and a cathodic efficiency of 84.4%, the potentiostat delivered an electrical energy input of ˜0.93 kWh/kg H₂O₂. This electrical energy input is significantly lower than that of conventional electrochemical systems for H₂O₂ production, which typically require about 4.4 to 8.9 kWh/kg H₂O₂ due to the requirement of an energy-intensive oxygen evolution reaction at the anode. This novel technology could therefore have important industrial implications. The global H₂O₂ market is estimated to be about 2.2 million tons, of which about 50% is used for pulp and paper bleaching. Notably, the pulp and paper industry also generates large amounts of organically loaded wastewater of which acetate and other easily biodegradable organics are common constituents. Thus, an ideal match between wastewater supply and H₂O₂ demand can possibly be established for this industry, which could significantly reduce the overall environmental impact of this industry.

In the present example, H₂O₂ was produced at a concentration of 0.13±0.01 wt %. This concentration is likely to be too low for recovery of H₂O₂ as a saleable product, but with some improvement will be highly suited for direct use onsite. Further experimental work using the same experimental apparatus as shown above has resulted in the production of a stream containing about 1% hydrogen peroxide, a substantial increase. Further improvements are anticipated.

One possible example where a stream of hydrogen peroxide could be used is in the Kraft process, which the most widely used process for pulp and paper bleaching. The Kraft, requires concentrations of at least 2 to 3 wt %. Further experimental work using the same experimental apparatus as shown above has resulted in the production of a stream containing about 1% hydrogen peroxide. The experimental runs show a decreasing cathodic efficiency at higher H₂O₂ concentrations (i.e. further into the experimental run), suggesting that the H₂O₂ is further reduced to water (H₂O₂+2H⁺+2e⁻). 2H₂O). Therefore, to achieve the concentrations of at least 2 to 3 wt %, efforts should be made to improve the efficiency, e.g., by increasing the oxygen concentration or by the addition of H₂O₂ stabilizers (e.g., EDTA, silicate).

The present example shows that H₂O₂ can be produced efficiently from acetate in a BES. At an applied voltage of 0.5 V, the investigated BES produced about 1.9±0.2 kg H₂O₂/m³/day at a concentration of 0.13±0.01 wt % and an overall efficiency of 83.1±4.8%. Later experiments have increased the hydrogen peroxide levels up to around 1%, with further improvements anticipated.

It will be appreciated by person skilled in the art that the present invention may be susceptible to variations and modifications other than those specifically described. For example, connecting multiple hydrogen peroxide producing bioelectrochemical systems in series in a bipolar stack design as commonly done for other electrochemical systems can also be done for the present invention. It will be understood that the present invention encompasses all such variations and modifications that fall within its spirit and scope.

Throughout the specification, the term “comprising” and its grammatical equivalents shall be taken to have an inclusive meaning unless the context indicates otherwise.

The applicant does not concede that the prior art discussed in the specification forms part of the common general knowledge in Australia or elsewhere.

The term “(in)organic” shall be taken to refer to both inorganic material and organic material.

1. A process for producing hydrogen peroxide comprising the steps of providing a bioelectrochemical system having an, anode and a cathode, feeding a feed solution containing organic or inorganic (or both) material to the anode, oxidising, the organic or inorganic material at the anode, providing an aqueous stream to the cathode of the bioelectrochemical system, reducing oxygen to hydrogen peroxide at the cathode, and recovering a hydrogen peroxide containing stream from the cathode.

2. A process as claimed in claim 1 wherein the bioelectrochemical system includes electrochemically active microorganisms associated with at least the anode or anode compartment, and, a Wastewater stream containing organic and/or inorganic pollutants is supplied to an amide compartment, said electrochemically active microorganisms effecting transfer of electrons to the anode while they are oxidising organic or inorganic pollutants in the wastewater streams.

3. A process as claimed in claim 1 wherein an oxygen containing gas is fed to a cathode chamber which contains the cathode.

4. A process is claimed in claim 3 further comprising removing surplus gas from the cathode chamber.

5. A process as claimed in claim 1 wherein the cathode is catalyzed chemically and consumes electrons for the reduction of oxygen to hydrogen peroxide.

6. A process as claimed in claim 1 wherein the overall cell potential (cathode potential minus anode potential) for the production of hydrogen peroxide has a positive value.

7. A process as claimed in claim 1 wherein an external power source is connected between the anode and the cathode to apply an external voltage to the system to increase the rate of electrode reactions and increase the rate of production of hydrogen peroxide.

8. A process is claimed in claim 1 wherein the cathode comprises an electrically conductive material that is catalytic toward the formation of hydrogen peroxide from oxygen, said electrically conductive material being supported on a current collector, said current collector not being catalytic towards the decomposition of hydrogen peroxide.

9. A process as claimed in claim 1 wherein an aqueous stream in contact with the cathode contains a hydrogen peroxide stabiliser.

10. A process is claimed in claim 1 wherein the hydrogen peroxide containing stream recovered from the cathode has a concentration of hydrogen peroxide in the range of between 0.01 and 30 wt % preferably between 0.1 and 10 wt %, more preferably between 1 and 8 wt %.

11. A process as claimed in claim 1 wherein an aqueous stream comprising an oxygenated or an aerated aqueous stream is fed to the cathode.

12. A process as claimed in claim 1 wherein a cathode reaction either consumes protons or produces hydroxyl ions so that the pH in the cathode chamber increases and the ion permeable membrane that separates the anode and the cathode chamber comprises a cation exchange membrane whereby cations are transported from the anode to the cathode to compensate for electrons flowing from anode to cathode through the electrical circuit wherein a mixture of a hydroxide material and hydrogen peroxide is formed in the cathode chamber.

13. A process as claimed in claim 12 wherein a ratio of sodium hydroxide to hydrogen peroxide falls between 0.1:1 and 10:1, preferably between 0.5:1 and 5:1, more preferably between 1:1 and 3:1.

14. A process is claimed in claim 12 wherein the cation exchange membrane comprises a monovalent ion selective cation, exchange membrane said monovalent ion selective cation exchange membrane preventing multivalent cations being transported kohl anode to cathode to thereby minimise or prevent scaling in the cathode chamber and also preventing iron ions from moving from the anode to the cathode.

15. A process as claimed in claim 1 wherein the ion permeable membrane that separates the anode and the cathode chamber comprises an anion exchange membrane and anions are transported from the cathode to the anode to compensate for the negative charge of the electrons flowing from anode to cathode through the electrical circuit, said anion exchange membrane preventing multivalent cations being transported from anode to cathode to thereby minimise or prevent scaling in the cathode chamber and also preventing iron ions from moving from the anode to the cathode.

16. A process as claimed in claim 1 wherein water or an aqueous, stream is provided to the cathode chamber and said water or aqueous stream contains added salt ions or buffer to obtain a minimum level of conductivity.

17. A process as claimed in claim 1 wherein pH in the cathode chamber is controlled in the cathode by adding an acid to a level that hydroperoxide ion is not formed.

18. A process is claimed in claim 1 wherein the ion permeable membrane that separates the anode and the cathode chamber comprises a bipolar membrane, said bipolar membrane comprising a cation exchange layer on top of an anion exchange layer, the anion exchange layer being directed towards the anode chamber and the cation exchange layer being directed towards the cathode chamber whereby electrical current flows, water diffuses in between the ion exchange layers and is split into protons and hydroxyl ions, the hydroxyl ions migrate through the anion exchange layer into the anode chamber where the hydroxyl ions compensate for the proton production in the anode reaction and protons migrate through the cation exchange layer into the cathode chamber where the protons compensate for hydroxyl ion production or proton consumption in the cathode reaction, said bipolar membrane preventing multivalent cations being transported from anode to cathode to thereby minimise or prevent scaling in the cathode chamber and also preventing iron ions from moving from the anode to the cathode.

19. A process is claimed in claim 1 wherein the ion permeable membrane comprises a porous membrane.

20. A process as claimed in claim 1 wherein a gas diffusion electrode is used as the cathode.

21. A process as claimed in claim 1 wherein the fluid provided to the cathode includes one or Mae anti-scaling agents.

22. A bioelectrochemical system for producing hydrogen peroxide comprising an anode chamber having an anode, an anode liquid inlet for feeding an aqueous waste stream to the anode chamber, an anode liquid outlet for removing a liquid from the anode chamber, the anode comprising a biocatalyzed anode which oxidises organic or inorganic materials in the aqueous waste stream fed to the anode chamber, a cathode chamber having a cathode, a cathode liquid inlet for feeding an aqueous stream to the cathode chamber, a cathode liquid outlet for removing a product stream containing hydrogen peroxide from the cathode chamber an ion permeable membrane between the anode chamber and the cathode chamber to allow the transfer of ions between the anode chamber and the cathode chamber and an electrical circuit connecting the anode and the cathode.

23. A system as claimed in claim 22 further comprising a cathode gas inlet for feeding an oxygen containing gas to the cathode chamber.

24. A system as claimed in claim 23 further comprising a cathode gas outlet for removing surplus gas from the cathode chamber.

25. A system as claimed in claim 22 wherein the system includes electrochemically active microorganisms associated with at least the anode or anode compartment, which transfer electrons to an electrode (anode) while they are oxidising (in)organic pollutants in an aqueous waste streams.

26. A system as claimed in claim 22 further comprising an external power source connected between the anode and the cathode.

27. A system as claimed in claim 22 wherein the bioelectrochemical system comprises an anode chamber and a cathode chamber separated by an ion permeable membrane.

28. A system is claimed in claim 27 wherein the ion permeable membrane is selected from ion exchange membranes, cation exchange membranes, anion exchange membranes, porous membranes, or bipolar membranes.

29. A system as claimed in claim 22 wherein the bioelectrochemical cell comprises an open flow system.

30. A system as claimed in claim 22 wherein the cathode comprises an electrically conductive material that is catalytic toward the formation of hydrogen peroxide from oxygen.

31. A system as claimed in claim 30 wherein the electrically conductive material is supported on a current collector, said current collector not being catalytic towards the decomposition of hydrogen peroxide.

32. A system as claimed in claim 22 wherein the system includes an anode chamber and the anode chamber is provided with an anode chamber liquid inlet and an anode chamber liquid outlet.

33. A system as claimed in claim 22 wherein the system includes a cathode chamber and the cathode chamber is provided with a cathode chamber liquid inlet.

34. A system as claimed in claim 22 wherein the membrane comprises a fluid permeable membrane such a fluid can flow across the membrane.

35. A system as claimed in claim 27 wherein the ion permeable membrane that separates the anode and the cathode chamber comprises a cation exchange membrane.

36. A system as claimed in claim 35 wherein the cation exchange membrane comprises a monovalent ion selective cation exchange membrane.

37. A system as claimed in, claim 27 wherein the ion permeable membrane that separates the anode and the cathode chamber comprises an anion exchange membrane.

38. A system as claimed in claim 27 wherein the ion, permeable membrane that separates the anode and the cathode chamber comprises a bipolar membrane comprising a cation exchange layer on top of an anion exchange layer, the anion exchange layer being directed towards the anode chamber and the cation exchange layer being directed towards the cathode chamber.

39. A system as claimed in claim 27 wherein the ion permeable membrane comprises a porous membrane and a fraction or the complete flow of an aqueous waste stream is directed through the porous membrane from anode to cathode.

40. A system as claimed in claim 27 wherein water or an aqueous stream enters the cathode through the cathode chamber liquid inlet between the cathode and the membrane in such a way that the fluid flow through the cathode chamber is perpendicular to the membrane in the direction of the cathode.

41. A system as claimed in claim 40 wherein the water or the aqueous stream passes through a porous membrane or a space and/or spacer is provided between the membrane and the cathode and the water or aqueous stream is directed through this space and/or spacer.

42. A system as claimed in claim 27 wherein a gas diffusion electrode is used as the cathode.
